(19) United States
(12) Patent Application Publication
(10) Pub. No.: US 2017/0341191 A1
(43) Pub. Date: Nov. 30, 2017

(54) METHOD AND DEVICE FOR ASSEMBLING AUTOMOBILE BODY

(71) Applicant: HONDA MOTOR CO., LTD., MINATO-KU, TOKYO (JP)

(72) Inventors: Kazuhisa HADA, TOCHIGI (JP); Kazuki AKAMI, TOCHIGI (JP); Masao SHIMOYAMA, TOCHIGI (JP)

(21) Appl. No.: 15/538,509

(22) PCT Filed: Dec. 3, 2015
(86) PCT No.: PCT/JP2015/084018

§ 371 Date: Jun. 21, 2017

(30) Foreign Application Priority Data
Dec. 26, 2014 (JP) 2014-264155

(51) Int. Cl. B23P 21/00; B62D 65/02; B23K 37/02; B23K 37/04

(52) U.S. Cl. CPC B23P 21/008; B62D 65/026; B23K 37/0247; B23K 37/0443

(57) ABSTRACT

Provided is a method for assembling an automobile body including an orientation-maintaining step in which outer side panels (2) and a roof (3) are brought into contact with predetermined parts of an inner skeleton (1) so as to be held in predetermined orientations, and a joining step in which the outer side panels (2) and the roof (3) which have been brought into contact in the orientation-maintaining step are joined to the inner skeleton (1) in a state of enabling to maintain at least an orientation as the automobile body.

### TECHNICAL FIELD

The present invention relates to an assembling method and an assembling device for an automobile body (vehicle body).

### BACKGROUND ART

Recently, a vehicle body is automatically assembled by using a jig and a robot. As such assembling method, there is known a technology to assemble the vehicle body by positioning an exterior member called a skin to an inside structure called an inner structure or all inner frame of the vehicle body, and then to join them by welding or the like (refer to Patent Literature 1: FIG. 2 or the like). The exterior member includes at least an outer side panel and a roof.

Moreover, the above Patent Literature 1 discloses an assembling mode of the vehicle body in which the floor and the side panels are welded, and then the roof is placed on the side panels and welded (refer to Patent Literature 1: FIG. 1 or the like). According to this configuration, there is less concern of the elastic deformation of the vehicle body after the welding, and it is able to improve the accuracy of the position of the vehicle body with the roof as the reference.

### PRIOR ART DOCUMENTS

### Patent Literature

Patent Literature 1: Japanese Patent Application Laid-Open No. 2014-129024

### SUMMARY OF INVENTION

### Problems to be Solved by the Invention

However, according to the technology disclosed in the above Patent Literature 1, the assembling facility is arranged to be capable of sharing both modes, including not only the mode of assembling by joining each skin member to the inner skeleton (structure body), but also the mode of assembling to form the vehicle body by welding assembled bodies to each other which are called “complete” composed of the inside members configuring the inner skeleton and the exterior members of the outer side thereof. In this case, the assembled bodies are the side panel composed of the inner side panel and the outer side panel, and the roof including a roof arch.

Therefore, in the mode of welding the assembled bodies, it is necessary to establish the joining orientation of the assembled bodies with respect to each other before welding the assembled bodies, which causes to increase the size or requires exclusiveness of the facility.

Furthermore, even in the monde of joining the skin member to the inner skeleton, a dedicated jig is used for each skin so as to position the skin before the welding, which causes to increase the size and complication of the facility.

In view of the above, it is an object of the present invention to provide an assembling method and an assembling device of a vehicle body which enables to avoid the burden of increasing the size of the facility or establishing additional facilities by enabling to position each skin with reference to the inner structure of the vehicle body with a simple configuration.

### Solution to the Problem

A method for assembling an automobile body of the present invention includes, an orientation-maintaining step of contacting a member configuring a skin part of the automobile body to a predetermined portion of art inner skeleton of the automobile body so as to maintain a predetermined orientation, and a joining step of forming the automobile body by joining the member which is in contact in the orientation-maintaining step, with respect to the inner skeleton until they are at least in a state of being able to maintain an orientation as the automobile body.

According to the present invention, the member configuring the skin part of the automobile body is brought into contact with the predetermined portion of the inner skeleton of the automobile body so as to maintain a predetermined orientation, and in such state, it is joined to the inner structure until becoming at least a state capable of maintaining the orientation as the automobile body, which enables to simply configure the assembling facility.

Moreover, the jig used for positioning the members configuring the skin part before the welding is not limited to those dedicated for each member, but may be a jig for general purpose.

An assembling device of an automobile body of the present invention includes: an outer side panel jig which engages an inner skeleton and an outer side panel, in a state the outer side panel of the automobile body being brought into contact with a reference portion of the inner skeleton of the automobile body so as to maintain a predetermined orientation; and a roof jig which brings a roof of the automobile body into contact with the outer side panel, in a state of the orientation of the outer side panel with respect to the inner skeleton being maintained by the outer side panel jig, and which includes an adjusting unit for adjusting a position of the roof.

According to the present invention, the state of the outer side panel of the automobile body being abut against the reference portion of the inner skeleton so as to keep the predetermined orientation is maintained by the outer side panel jig. Then, in such state, the roof is abut against the outer side panel and the position of the roof is adjusted.

Therefore, in such state, it is possible to join the outer side panel and the roof to the inner skeleton to at least a state in which an orientation as an automobile body can be maintained, thereby enabling to simply configure the assembling device of the automobile body.

The assembling device of the present invention further includes a detection unit which detects a reference portion of the inner skeleton, wherein the outer side panel jig operates to bring the outer side panel into contact with the reference portion detected by the detection unit.

As such, a facility for positioning the inner skeleton and for positioning the outer side panel with respect to the inner skeleton is not required, and it is able to abut the outer side panel against the inner skeleton with an appropriate position relationship. Therefore, it is able to simply configure the assembling device of the automobile body.

According to the assembling device of the present invention, the outer side panel jig and the roof jig may be attached to a conveying robot. As such, by performing teaching to the conveying robot, which corresponds to various vehicle types, it is possible to cope with assembling automobile bodies of various vehicle types.

### BRIEF DESCRIPTION OF DRAWINGS

FIG. 1A is a cross sectional diagram illustrating an automobile body called an inner skeleton, and FIG. 1B is a diagram illustrating a state of attaching a skin (outer side panel, roof) to the inner skeleton.

FIG. 2 is a perspective diagram illustrating a state immediately after emplacement of the inner skeleton at an assembling device of the automobile body of the present invention.

FIG. 3 is a perspective diagram illustrating a state when an outer side panel and a roof are conveyed to the inner skeleton or close to the inner skeleton at the assembling device of the automobile body of the present invention.

FIG. 4 is a perspective diagram illustrating a state of arranging the roof with respect to the outer side panel in a state the orientation of the outer side panel with respect to the inner skeleton is maintained at the assembling device of the automobile body of the present invention.

FIG. 5 is a perspective diagram illustrating a state of detecting a corresponding reference portion on the outer side panel in a state in which the orientation of the outer side panel with respect to the inner skeleton being maintained at the assembling device of the automobile body of the present invention.

FIG. 6 is a perspective diagram illustrating a state of abutting the roof against the outer side panel and adjusting its position at the assembling device of the automobile body of the present invention.

FIG. 7 is a flow chart showing an assembling process of the automobile body by using assembling device of the automobile body.

FIG. 8 is a diagram illustrating at configuration of a roof jig for contacting the roof with the outer side panel.

### DESCRIPTION OF EMBODIMENTS

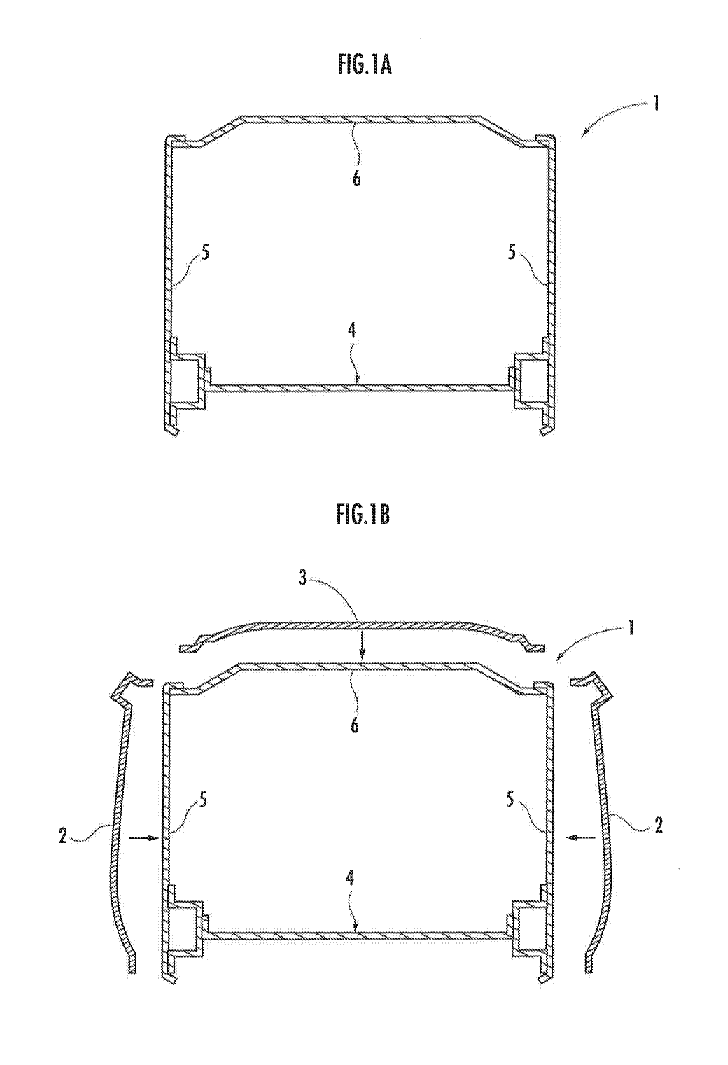

An embodiment of the present invention is explained hereinafter. According to the assembling method of an automobile (vehicle) body in the embodiment, as shown in FIG. 1B, an outer side panel 2 and a roof 3 is attached to an inner skeleton 1 shown in FIG. 1A, to form the vehicle body. The inner skeleton 1 is formed by attaching an inner side panel 5 to a floor 4 and by attaching a roof arch 6 to the inner side panel 5 in advance.

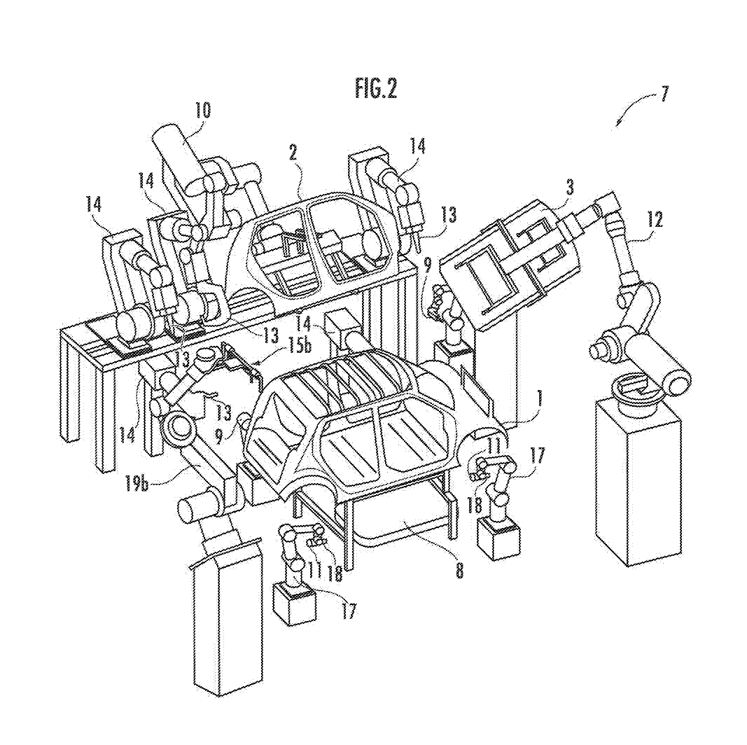

As shown in FIG. 2, an assembling device 7 of the vehicle body used in the assembling method of the vehicle body includes: a cart 8 placed with the inner skeleton 1 of the vehicle body thereon and which is received at a predetermined position; and four reference portion sensing robots 9 as detection units, two of them being arranged at each of right and left sides of the inner skeleton 1 for detecting four different reference portions of the inner skeleton 1. In FIG. 2 to FIG. 6, two of the reference portion sensing robots 9 existing at the right side (the nearer side of the figure) of the inner skeleton 1 are not illustrated.

Surrounding the cart 8 positioned at the predetermined position, two outer side panel conveying robots 10 which conveys each outer side panel 2, a plurality of outer side panel jigs 11, a roof conveying robot 12 which conveys the roof 3, a plurality of welding robots 14 including a welding gun 13, and two roof jigs 15a, 15b, are arranged. The outer side panel conveying robots 10 and a part of the welding robots 14 are provided to be capable of moving along the front-back direction of the inner skeleton 1 by a linear motor on a supporting table 16.

Here, in FIG. 2 to FIG. 6, one supporting table 16, one roof conveying robot 12, and four welding robots 14 are illustrated. However, the same elements are arranged at a position laterally symmetric with the cart 8 positioned at the predetermined position as the center.

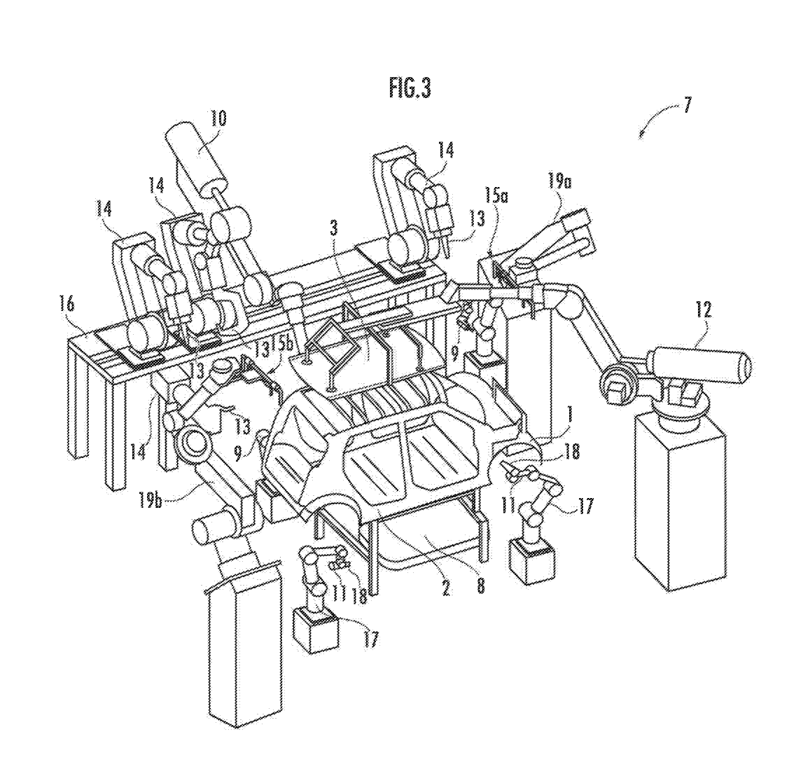

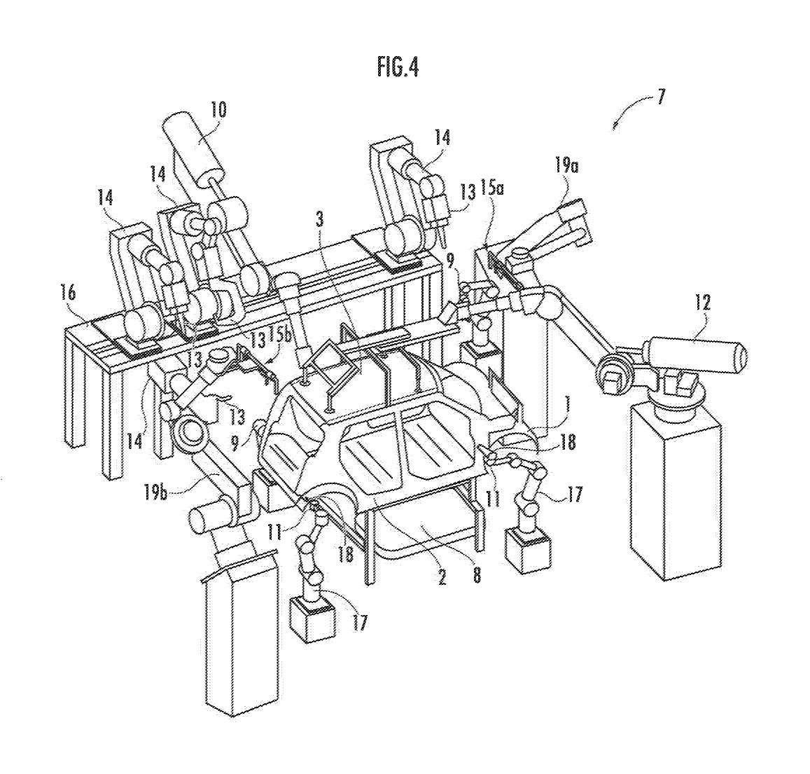

Each of the outer side panel jigs 11 is conveyed by a respective jig conveying robot 17. As shown in FIG. 3, in a state the outer side panel 2 of the vehicle body contacting the above mentioned reference portion of the inner skeleton 1 so as to maintain a predetermined orientation, each of the outer side panel jigs 11 engages to the inner skeleton 1 and the outer side panel 2. A state of this engagement is illustrated in FIG. 4 to FIG. 6.

As shown FIG. 4, this engagement is performed by fitting a fitting member 18 included in each of the outer side panels 11 to a corresponding fitting portion of the inner skeleton 1 and the outer side panel 2. Each fitting portion can be simply configured by a through hole to which the fitting member 18 is fit.

More specifically, it is configured by fitting the pin-like fitting member 18 to the through hole, and also pushing the outer side panel 2 to the inner skeleton 1 side with an appropriate force. In addition, an element for clamping the outer side panel 2 to the inner skeleton 1 may be added.

The roof jigs 15a and 15b bring the front part and the rear part of the roof 3 respectively into contact with the outer side panel 2 in a state in which the orientation of the outer side panel 2 with respect to the inner skeleton 1 is held and maintained by the outer side panel jig 11. The roof jigs 15a and 15b are conveyed by a respective jig conveying robots 19a and 19b.

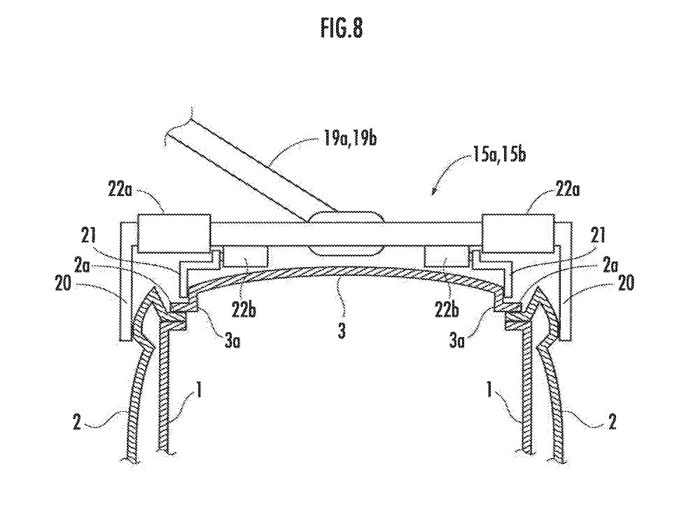

As shown in FIG. 8, the roof, jig 15a includes right and left contact members 20 which respectively contact the right and left front parts of the outer side panels 2, and also includes right and left contact members 21 which respectively contact the right and left flange parts 3a of the front part of the roof 3. The right and left contact members 20 contact the upper end portions of the outer side panels 2 from the outer right and left sides, respectively.

The flange part 3a of the roof 3 is configured by a bent portion which is bent approximately 90° substantially in the vertical direction and a bent portion which is further bent in the horizontal direction, in a state in which the roof 3 is placed on the outer side panel 2. The contact members 21 contact the upper portions of the bent portions which are bent in the vertical direction (root portions of the flanges 3a) from outer right and left sides, respectively.

The roof 3 is placed on the outer side panels 2 such that the bent portions in the horizontal direction of the flange parts 3a contact joining parts 2a which are bent in the horizontal direction at upper inner sides of the outer side panels 2. Then, by adjusting this placement position, accurate contact of the roof 3 with respect to the outer side panels 2 is realized.

The right and left contact members 20 are respectively driven by right and left servo cylinders 22a each having a stroke in the vehicle width direction (right and left direction). The right and left contact members 21 are respectively driven by right and left servo cylinders 22b each having a stroke in the vehicle width direction. Similarly, the roof jig 15b which brings the rear parts of the roof in contact with the outer side panels 2 is configured by contact members 20, contact members 21, servo cylinders 22a, and servo cylinders 22b.

When the roof jigs 15a and 15b bring the roof 3 into contact with the outer side panels 2, the contact members 20 are brought into contact with the outer side panels 2 by the servo cylinders 22a to recognize the position of the outer side panels 2 in the vehicle width direction.

Then, based on this recognized position, the contact members 21 are brought into contact with the root portions of the flange parts 3a of the roof 3 (the upper end portions of the bent portions in the vertical direction in the flange parts 3a) by the servo cylinders 22b, the position of the roof 3 with respect to the outer side panels 2 in the vehicle width direction is appropriately adjusted by moving the roof in the vehicle width direction.

In other words, the adjusting unit which adjusts the position of the roof 3 with respect to the outer side panels 2 is configured by the contact members 21 and the servo cylinders 22b. Upon such adjustment, by providing a difference between the moving amount between the right and left contact members 21, the elastic deformation in the vehicle width direction caused by the self weight of the roof 3 when the roof 3 is placed on the outer side panels 2, is corrected. This realizes further accurate contact of the roof 3 with respect to the outer side panels 2.

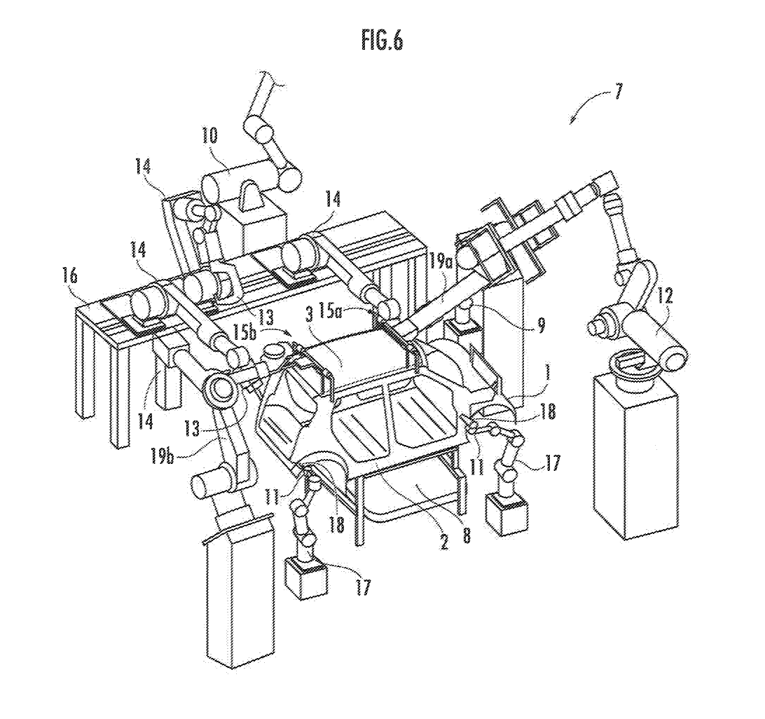

As shown in FIG. 6, welding is performed by a welding robot 13 to the outer side panels 2 and the roof 3 whose position having been adjusted with respect to the outer side panels 2 as described above, thereby allowing a state in which the orientation as a vehicle body can be maintained.

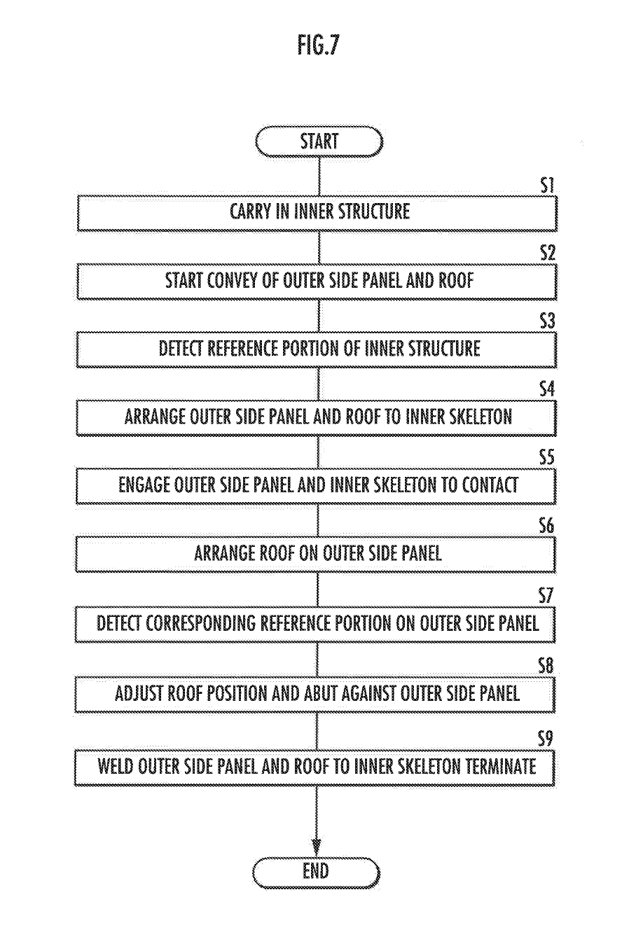

When assembling the vehicle body according to the assembling method of the vehicle body of the present embodiment, an assembling process of the vehicle body shown in FIG. 7 is performed by a control unit (which is not illustrated) of the assembling device 7 of the vehicle body. This assembling process includes an orientation-maintaining step and a joining step which will be described later.

In other words, when the assembling process is started, first, the control unit carries in the inner skeleton 1 to inside of the assembling device 7 by receiving the cart 8 on which the inner skeleton 1 is placed to a predetermined position in the assembling device 7 of the vehicle body (STEP S1). In FIG. 2, the cart 8 received at the predetermined position is illustrated.

Next, the conveying of the outer side panels 2 by right and left outer side panel conveying robots 10 and the conveying of the roof 3 by the roof conveying robot 12, are started (STEP S2). FIG. 2 illustrates the state during theses conveyance. Moreover, during the conveyance, each of the four reference portions of the inner skeleton 1 is detected by four reference portion sensing robots 9, respectively, and the positions are stored (STEP S3).

Next, based on the stored positions of the reference portions, each outer side panel 2 is arranged at the corresponding reference portion of the inner skeleton 1 by the outer side panel conveying robot 10 (STEP S4). Although FIG. 3 does not illustrate the outer side panel conveying robot 10 on the right side, the outer side panel 2 on the right side which has been arranged by this robot, is illustrated.

Next, the inner skeleton 1 and each outer side panel 2 arranged at the reference portion of the inner skeleton 1 are engaged by the corresponding outer side panel jig 11 (STEP S5). As such, it becomes a state in which the outer side panels 2 are brought into contact with respect to the reference portions of the inner skeleton 1 so as to maintain the predetermined orientation.

This engagement of the inner skeleton 1 and the outer side panels 2 is performed, based on the position of the reference portions stored in STEP S3, by driving the jig conveying robot 17, fitting the fitting member 18 of each outer side panel jig 11 to the corresponding fitting parts of the inner skeleton 1 and the outer side panels 2, and pushing the outer side panels 2 with respect to the inner skeleton 1 by an appropriate force. The state of performing this engagement is illustrated in FIG. 4.

Next, based on the reference portion stored in STEP03, the roof conveying robot 12 places the conveyed roof 3 on the right and left outer side panels 2 (STEP S6). FIG. 4 illustrates the state when this arrangement has been performed.

At this time, the flex of the roof 3 due to its own weight is suppressed to some degree by an roof arch attached to the roof 3 in advance and the roof arch 6 of the inner skeleton 1 attached to the inner side panels 5. However, when the roof conveying robot 12 releases the roof 3, the roof 3 elastically deforms to some degree by its own weight, and expands in the vehicle width direction.

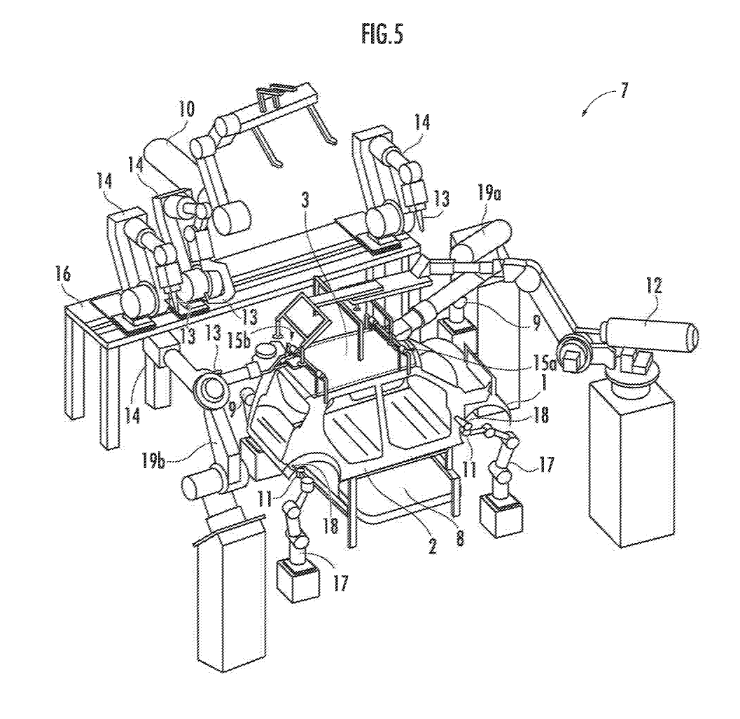

Next, as shown in FIG. 5, the outer side panel conveying robot 10 and the roof conveying robot 12 are retracted, and also the corresponding reference portion on the outer side panel 2 is detected by the each of the reference portion sensing robots 9, and such position is stored (STEPS7).

Next, based on the stored position, each of the jig conveying robots 19a and 19b is driven to arrange the roof jigs 15a and 15b at the predetermined positions on the outer side panels 2. Then, the position of the roof 3 is adjusted by the roof jigs 15a and 15b so that the roof 3 contacts the outer side panels 2 with a correct positional relation in the vehicle width direction (STEP S8).

That is, as shown in FIG. 8, the right and left contact members 20 are brought into contact with the upper end parts of the outer side panels 2 by right and left servo cylinders 22a of the roof jigs 15a and 15b, and the positions of the outer side panels 2 in the vehicle width direction are recognized. Then, based on the recognized positions, the position of the roof 3 is moved in the vehicle width direction so that the roof 3 is positioned at the correct position in the vehicle width direction with respect to the outer side panels 2.

This movement is performed by contacting the right and left contact members 21 to the root portion of the right and left flange parts 3a of the roof 3 by the right and left servo cylinders 22b of the roof jigs 15a and 15b, and pushing the roof 3 in the vehicle width direction. At this time, by generating a difference in the driving amount of the right and left servo cylinders 22b, the dimension which had been enlarged in the vehicle width direction by the elastic deformation due to the self weight of the roof 3, can be also corrected. By doing so, the roof 3 becomes a state of contacting the outer side panels 2 at the correct position in the vehicle width direction.

Accordingly, the outer side panels 2 and the roof 3 as the skin part becomes a state of being brought into contact with the predetermined portions of the inner skeleton 1 of the vehicle body so as to maintain the predetermined orientation, and the orientation-maintaining step is completed. That is, the processing of STEPs S3 to S8 are included in the orientation-maintaining step.

Next, the joining step is performed. That is, the outer side panels 2 and the roof 3, which have been brought into contact with the predetermined portions of the inner skeleton 1 in steps S4, S5, and S8, are welded to the inner skeleton 1 to be joined by each welding robot 14 (STEP S9). The place to be welded is set to a place, so that at least a state which enables to maintain an orientation as the vehicle body is obtained by the welding.

FIG. 6 shows a state of performing such welding by a part of the welding robots 14. When this welding is completed, the vehicle body is transferred from the assembling device 7 of the vehicle body to another device for another step.

As described above, according to the present embodiment, the outer side panels 2 and the roof 3 which configures the skin part of the vehicle body are brought into contact with the predetermined portions of the inner skeleton 1 of the vehicle body so as to maintain a predetermined orientation, and joined to the inner skeleton 1 to at least a state in which the orientation as the vehicle body can be maintained. Therefore, it is able to simply configure the assembling facility.

Moreover, by maintaining a state in which the outer side panels 2 of the vehicle body is brought into contact with the reference portions of the inner skeleton 1 so as to maintain the predetermined orientation, in such state, the roof 3 is brought into contact with the outer side panels 2 and the position of the roof 3 is adjusted. Therefore, it is able to join the outer side panels 2 and the roof 3 to the inner skeleton 1 in such state until it becomes at least a state capable of maintaining the orientation as the vehicle body. Accordingly, it is able to simply configure the assembling device 7 of the vehicle body.

Moreover, the outer side panel jig 11 is actuated so as to bring the outer side panel 2 into contact with the detected reference portion of the inner skeleton 1. Therefore, a facility to position the inner skeleton 1 and to position the outer side panels 2 with respect to the inner skeleton 1 is not required. As such, it is able to simply configure the assembling device 7 of the vehicle body.

Moreover, since the outer side panel jig 11 and the roof jigs 15a, 15b are attached to the jig conveying robots 17 and 19a, 19b, it is able to cope with vehicle body assembling of various types of vehicles by providing the jig conveying robots 17 and 19a, 19b with a teaching which corresponds to various vehicle types.

The embodiment of the present invention is explained as described above. However, the present invention is not limited thereto. For example, the jigs used for positioning the members configuring the skin part before the welding, are not limited to those dedicated for each member, but may be those for general purpose.

### REFERENCE SIGNS LIST

1 inner skeleton
2 outer side panel (skin part)
3 roof (skin part)
4 floor
7 assembling device
9 sensing robot (detection unit)
11 outer side panel jig
15a, 15b roof jig
17, 19a, 19b jig conveying robot
21 contact member (adjusting unit)
22b servo cylinder (adjusting unit)

1. A method for assembling an automobile body comprising:
an orientation-maintaining step of contacting a member configuring a skin part of the automobile body to a predetermined portion of an inner skeleton of the automobile body so as to maintain a predetermined orientation; and
a joining step of forming the automobile body by joining the member which is in contact in the orientation-maintaining step, with respect to the inner skeleton until they are at least in a state of being able to maintain an orientation as the automobile body.

2. An assembling device of an automobile body comprising:
an outer side panel jig which engages an inner skeleton and an outer side panel, in a state the outer side panel of the automobile body being brought into contact with a reference portion of the inner skeleton of the automobile body so as to maintain a predetermined orientation; and
a roof jig which brings a roof of the automobile body into contact with the outer side panel, in a state of the orientation of the outer side panel with respect to the inner skeleton being maintained by the outer side panel jig, and which includes an adjusting unit for adjusting a position of the roof.

3. The assembling device according to claim 2, comprising a detection unit which detects a reference portion of the inner skeleton, wherein the outer side panel jig operates to bring the outer side panel into contact with the reference portion detected by the detection unit.

4. The assembling device according to claim 2, wherein the outer side panel jig and the roof jig are attached to a conveying robot.
